(19) United States
(12) Patent Application Publication
(10) Pub. No.: US 2006/0016920 A1
(43) Pub. Date: Jan. 26, 2006

(54) Device for feeding wood chips to a processing unit

(76) Inventors: Wolfgang Holzer, Wallhalben (DE); Thomas Freichel, Lebach (DE); Dan Nielsen, Cambridge (CA)

Correspondence Address: WILLIAM COLLARD;COLLARD & ROE, P.C., 1077 NORTHERN BOULEVARD, ROSLYN, NY, 11576, US

(21) Appl. No.: 11/131,802

(22) Filed: May 18, 2005

(30) Foreign Application Priority Data
May 18, 2004 (DE) 202004008214.4

(51) Int. Cl. B02C 19/00

(52) U.S. Cl. 241/62

(57) ABSTRACT

A device for feeding wood chips to a processing unit, comprises a deflection surface in the device, that extends into a direct delivery path of the wood chips, a delivery unit for delivering air through at least one air admission opening in the deflection surface, and at least one air outlet opening in the device, the opening being positioned in the direction of air flow. The deflection surface ensures that the wood chips are held up at this point during the transport, so that the dwell time of the wood chips is extended. Because air is delivered through the deflection surface, the wood dust is swirled between the wood chips. This swirled wood dust is taken away along with the air blown in through the air outlet opening. This allows for a substantial reduction in the amount of wood dust in the wood chips during the further processing.

### BACKGROUND OF THE INVENTION

1. Field of the Invention

The invention concerns a device for feeding wood chips to a processing unit.

2. The Prior Art

Devices for feeding wood chips to processing units are known. Wood chips are used, for example, to make wood fiber board, such as OSB board or particle board. For this, the wood is first shredded. After the shredding, the wood shavings are sized with glue and then pressed into the final product. In order to have sufficient material available in the individual processing steps, the wood chips are placed in an interim stockpile. From this interim stockpile, the wood chips are then transported via a feeding device to the glue sizing device.

Such a feeding device can be formed, for example, by an outlet opening at the lower end of a dry chip hopper, forming the interim stockpile for the wood chips. From this outlet opening, the wood chips can be fed to the sizing device, for example, via a downpipe system.

### SUMMARY OF THE INVENTION

It is an object of the invention to improve the feeding of the wood chips in conjunction with their further processing.

This problem is solved with a feeding device having a deflection surface that extends into the direct delivery path of the wood chips, and air can be delivered by means of a delivery unit through air admission openings in the deflection surface. There is at least one air outlet opening in the feeding device in the direction of the air flow.

It has been found that wood dust gets mixed in with the wood chips due to the shredding, stockpiling, and transport of the wood. In particular, when the wood is to be sized with glue in connection with its further processing, for example, in order to press boards, this wood dust is a disturbance, because glue also sticks to the dust particles, and this sized dust does not get incorporated into the board, but instead contaminates the processing machinery. This proves to be especially troublesome when the processing machines are contaminated with glue, because it can only be removed with great expense.

The deflection surface advantageously ensures that the wood chips are held up at this point during the transport, so that the dwell time of the wood chips in this zone is extended. Because air continues to be delivered through the deflection surface, the wood dust is favorably swirled into an eddy between the wood chips in this zone. This swirled wood dust is taken away along with the air blown in through the air outlet opening. This allows for a substantial advantageous reduction in the amount of wood dust in the wood chips during the further processing.

As already explained, the reduction in the dust fraction among the wood chips proves to be especially advantageous when the wood chips are glue sized in the further processing.

In one embodiment, an air delivery channel extends behind the air outlet opening, through which air can be evacuated by means of an additional air delivery means.

In addition to the blown air, which is delivered through the at least one opening in the deflection surface, the air with the swirled dust is vacuumed up and taken away in a controlled manner. This further advantageously improves the separating of the dust from the wood being processed. Since the dust is taken away in an orderly manner, the work safety is further improved.

In another embodiment, a grid is provided in the region of the air outlet opening.

This advantageously allows one to prevent wood chips from being taken away as well through the air outlet opening. The mesh size of the grid has to be adapted to the size of the wood chips for this to occur.

In another embodiment, the cross section of the feeding device is widened in the region of the deflection surface. This advantageously provides enough room in this place for the wood chips to spread out here as the delivery speed is slowed down. Furthermore, an efficient swirl can be produced in this enlarged volume of dust, so that the dust can then also be carried away.

In yet another embodiment, the delivery device consists of one or more cylinder fans.

This advantageously makes it possible to produce a largely homogeneous air flow, with which the dust can be efficiently swirled. Advantageously, these cylinder fans also have frequency control. In this way, the delivery performance can be further easily adapted to the dust fraction, the quantity of wood delivered in a unit of time, and the size of the wood chips.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

FIG. 1 shows one embodiment of the feeding device according to the invention.

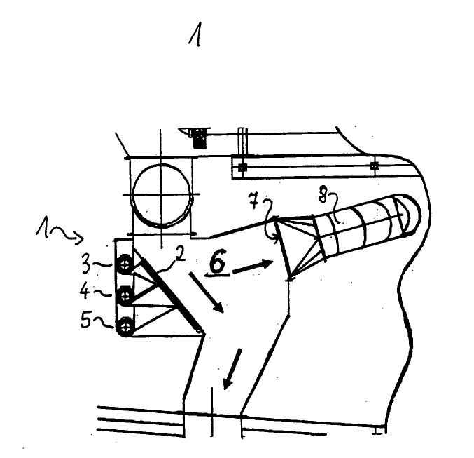

### DETAILED DESCRIPTION OF THE PREFERRED EMBODIMENT

The figure shows a feeding device 1. This feeding device consists of a pipe, which is arranged at its entry end at an opening of a dry chip hopper, which is located at the lower end of the dry chip hopper. The opening can be closed. The wood chips fall down by force of gravity through the feeding device 1 when this opening is opened. In addition, a delivery device can also be present for the wood chips, with which a better defined stream of dry chips can be achieved.

A deflection surface 2 is present, extending into the direct delivery path of the wood chips. By this deflection surface 2, the wood chips are braked and held up for a certain time in the neighborhood 6 of this deflection surface 2 in feeding device 1.

Feeding device 1 is widened in its cross section in the neighborhood 6 of deflection surface 2, so that a larger volume is formed locally there.

Deflection surface 2 can consist, for example, of a grid, whose mesh is of such size that no wood chips can drop through it.

As can be further seen, in the sample embodiment represented there are three cylinder fans 3, 4, 5 present as delivery devices for air. With these cylinder fans 3, 4, 5, air can be delivered through deflection surface 2. Advantageously, the quantity of air delivered can be further adjusted by frequency control of the cylinder fans.

In this way, the wood chips as well as the dust located in the wood chips are swirled.

As can be further seen, an air outlet opening 7 is arranged at the side of feeding device 1 opposite deflection surface 2, looking in the direction of the air flow.

Air outlet opening 7 is continued by an air delivery channel 8, which adjoins air outlet opening 7.

Advantageously, a separate air delivery unit is also present, by means of which the air with the swirled dust can be evacuated through air outlet opening 7 and air delivery channel 8.

Advantageously, a grid is provided in the region of air outlet opening 7, whose mesh is advantageously adjusted so that no wood chips can pass through.

Filter systems can be provided in air delivery channel 8, in order to separate the dust there.

Accordingly, while only a few embodiments of the present invention have been shown and described, it is obvious that many changes and modifications may be made thereunto without departing from the spirit and scope of the invention.

What is claimed is:

1. A device for feeding wood chips to a processing unit, comprising:
a deflection surface in the device, said surface extending into a direct delivery path of the wood chips;
a delivery unit for delivering air through at least one air admission opening in the deflection surface; and
at least one air outlet opening in the device, said opening being positioned in the direction of air flow.

2. A feeding device according to claim 1, further comprising an air delivery channel extending behind the air outlet opening, through which air can be evacuated by means of an additional air delivery means.

3. A feeding device according to claim 1, further comprising a grid in the region of the air outlet opening.

4. A feeding device according to claim 1, wherein a cross section of the feeding device is widened in a region of the deflection surface.

5. A feeding device according claim 1, wherein the delivery device consists of one or more cylinder fans.
